(19) United States
(12) Patent Application Publication
(10) Pub. No.: US 2017/0065493 A1
(43) Pub. Date: Mar. 9, 2017

(54) FEEDING TUBE

(71) Applicant: AMBIENTE Handels-GmbH, Neufeld an der Leitha (AT)

(72) Inventor: Verena SCHWARZ, Allhaming (AT)

(73) Assignee: AMBIENTE Handels-GmbH, Neufeld an der Leitha (AT)

(21) Appl. No.: 15/308,857

(22) PCT Filed: May 5, 2014
(86) PCT No.: PCT/AT2014/050112

§ 371 Date: Nov. 4, 2016

(51) Int. Cl. A61J 15/00

(52) U.S. Cl. CPC A61J 15/0073; A61J 15/0042; A61J 15/0015; A61J 15/0092

(57) ABSTRACT

The invention relates to a feeding tube, comprising a shaft (2) which adjoins a tube head (1) and has at least two channels (3, 4), namely a food channel (3) and a fluid channel (4), said shaft carrying at its end a balloon (5) which is connected to the fluid channel (4) and is penetrated by the food channel (3), wherein the tube head (1) comprises supply connections (6, 7) for the channels (3, 4). with the supply connections being fitted with valves (8, 9). In order to provide advantageous constructive conditions, it is proposed that the tube head (1), which forms a tube part that is separate from the shaft (2) forms a plug-in coupling for the shaft (2), which shaft can be cut to length, for connecting the channels (3, 4) to the associated supply connections (6, 7).

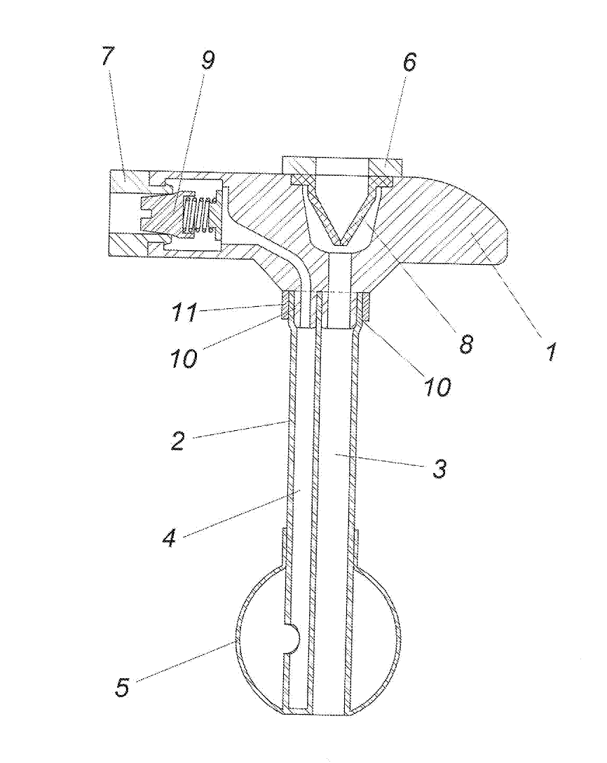

### FIELD OF THE INVENTION

The invention relates to a feeding tube, comprising a shaft which adjoins a tube head and has at least two channels, namely a food channel and a fluid channel, said shaft carrying at its end a balloon which is connected to the fluid channel and is penetrated by the food channel, wherein the tube head comprises supply connections for the channels, with the supply connections being fitted with valves.

### DESCRIPTION OF THE PRIOR ART

It is known for supplying food through the abdominal wall (U.S. Pat. No. 5,997,503) to use feed tubes having a shaft which penetrates the abdominal wall through a stoma, which shaft is provided within the stomach with a balloon resting on the stomach wall and on the exterior side, of the abdominal wall with a tube head, so that the feed tube is tightly held between the tube head and the balloon in relation to the abdominal wall. The shaft of the feed tube is provided with a food channel which penetrates the balloon and opens into the stomach. Respectively prepared food can thus be introduced into the stomach via, a supply connection which is provided in the tube head and is connected to the food channel via a nonreturn valve. A fluid channel which opens into the balloon is provided in the shaft of the feed tube for filling the balloon, said fluid channel being supplied with a fluid, which is usually air or water, via a further supply connection of the tube head and a valve that is spring-loaded in the closing sense, The balloon can also be discharged via the supply connection associated with the fluid channel in order to remove the feed tube from the stoma.

By fixing the feed tube between the balloon and the tube head, the length of the shaft needs to be adjusted to the thickness of the abdominal wall of the respective patient. This means that feeds tubes with graduated lengths of the shaft need to be provided, which requires a considerable effort concerning production and storage.

### SUMMARY OF THE INVENTION

The invention is thus based on the object of providing a feed tube which allows a simple consideration of the respective thickness of the abdominal wail.

On the basis of a feed tube of the kind mentioned above, this object is achieved by the invention in such a way that the tube head, which forms a tube part that is separate from the shaft, forms a plug-in coupling for the shaft, which shaft can be cut to length, for connecting the channels to the associated supply connections,

The separation of the tube head from the shaft of the feed tube provides a precondition for precise, individual adjustment of the shaft length to the anatomical conditions, because the shaft merely needs to be cut to length according to the predetermined conditions. The required subsequent connection between the shaft and the tube head no longer poses any problems due to the provided plug-in coupling for connecting the channels of the shaft to the associated supply connections.

The constructive configuration of the plug-in coupling for connecting the channels of the shaft to the associated supply connections in the tube head can be provided in different ways, since only a liquid-tight or fluid-tight connection is relevant. One possibility for connecting the shaft to the tube head is to provide a plug-in receptacle in the tube head for the coupling, end of the shaft that was cut to length. It is necessary to ensure in this case that after the insertion of the coupling end of the shaft into the plug-in receptacle of the tube head the channels of the shaft are connected in a sufficiently tight manner to the tube head, which is achieved for example by a glued connection between the tube head and the face end of the coupling end of the shaft that was cut to length. Seals disposed on the face end for the shaft channels can also be provided for this purpose in the tube head.

The plug-in coupling can comprise coupling connectors engaging in the channels of the shaft so that each tube channel can be connected separately via the plug-coupling to the associated supply connection. If the coupling connectors which protrude against the coupling end of the shaft that was cut to length comprise a tapering insertion end, the insertion of the coupling connectors associated with the tube head into the channels of the shaft is facilitated.

Since generally the shaft is made from a respectively flexible plastic, the protruding coupling connectors of the tube head are enclosed by the channel walls of the shaft under elastic pretension, which usually ensures adequate connection between the tube head and the coupling end of the shaft. The coupling end of the shaft can be enclosed additionally with a securing sleeve for the purpose of improving this connection.

### BRIEF DESCRIPTION OF THE DRAWING

The subject matter of the invention is shown in the drawing by way of example, which shows a feed tube in accordance with the invention in a schematic longitudinal sectional view.

### DESCRIPTION OF THE PREFERRED EMBODIMENT

The illustrated feed tube comprises a shaft 2 which is connected to a tube head 1 and forms two channels 3 and 4, namely a food channel 3 for supplying food and a fluid channel 4 for filling and discharging a balloon 5 provided at the end of the shaft 2. The two channels 3, 4 of the shaft 2 are provided with respective supply connections 6, 7. The supply connection 6 for the supply of food or medications is provided with a nonreturn valve 8 via which food preparations or medications can be introduced into the stomach via the food channel 3 which penetrates the balloon 5. The supply connection 7 for the fluid channel 4 comprises a valve 9 which is spring-loaded in the closing sense and via which the balloon 5 can be filled with a fluid such as water. A discharge of the balloon 5 is also possible via said valve 9.

In contrast to conventional feed tubes of this kind, the tube head 1 represents a tube part which is separate from the shaft 2, to which the shaft 2 can be connected after being cut to a predetermined length. For this purpose, the tube head 1 forms a plug-in coupling for the shaft 2. Said plug-in coupling could consist of a plug-in receptacle in the tube head 1 which is adapted to the outer circumference of the shaft 2. According to the illustrated embodiment, the tube head 1 forms coupling connectors 10 for the two channels 3, 4 of the shaft 2, which connectors protrude against the coupling end of the shaft 2 and which preferably engage in the shaft 2 by widening the channel walls, so that the shaft 2, with its coupling end, encloses the coupling connectors 10 of the tube head 1 with elastic pretension. For the purpose of securing the connection between the shaft 2 and the coupling connectors 10, the coupling end of the shaft 2 can additionally be enclosed by a securing sleeve 11.

1. A feeding tube, comprising a shaft (2) which adjoins a tube head (1) and has at least two channels (3, 4), namely a food channel (3) and a fluid channel (4), said shaft carrying at its end a balloon (5) which is connected to the fluid channel (4) and is penetrated by the food channel (3), wherein the tube head (1) comprises supply connections (6, 7) for the channels (3, 4), with the supply connections being fitted with valves (8, 9), wherein the tube head (1), which forms a tube part that is Separate from the shaft (2), forms a plug-in coupling for the shaft (2), which shaft can be cut to length, for connecting the channels (3, 4) to the associated supply connections (6, 7).

2. A feed tube, according to claim 1, wherein the plug-in coupling comprises coupling connectors (10) engaging in channels (3, 4) of the shaft (2).

3. A feed tube according to claim 2, wherein the coupling connectors (10), which protrude against the coupling end of the shaft (2) which is cut to length, comprise a tapering insertion end.

4. A feed tube according to claim 2, wherein the coupling end of the shaft (2) is enclosed by a securing sleeve (11).
